(19) United States
(12) Patent Application Publication
(10) Pub. No.: US 2008/0165442 A1
(43) Pub. Date: Jul. 10, 2008

(54) System, method and apparatus for cloaking

(76) Inventors: Wenshan Cai, West Lafayette, IN (US); Vladimir M. Shalaev, West Lafayette, IN (US); Uday K. Chettiar, West Lafayette, IN (US); Alexander V. Kildishev, West Lafayette, IN (US)

Correspondence Address: BRINKS HOFER GILSON & LIONE, P.O. BOX 10395, CHICAGO, IL, 60610, US

(21) Appl. No.: 11/983,228

(22) Filed: Nov. 7, 2007

Related U.S. Application Data
(60) Provisional application No. 60/857,526, filed on Nov. 8, 2006.

(51) Int. Cl. G02B 27/00

(52) U.S. Cl. 359/896

(57) ABSTRACT

An apparatus and method of cloaking is described. An object to be cloaked is disposed such that the cloaking apparatus is between the object and an observer. The appearance of the object is altered and, in the limit, the object cannot be observed, and the background appears unobstructed. The cloak is formed of a metamaterial where the properties of the metamaterial are varied as a function of distance from the cloak interfaces, and the permittivity is less than unity. The metamaterial may be fabricated as a composite material having a dielectric component and inclusions of particles of sub-wavelength size, so as to have a permeability substantially equal to unity.

This application claims the benefit of U.S. provisional application Ser. No. 60/857,526, filed on Nov. 8, 2006, which is incorporated herein by reference.

### STATEMENT OF GOVERNMENT SUPPORT

This application is based on research sponsored by the U.S. Army Research Office under 50342-PH-MUR.

### TECHNICAL FIELD

This application relates to a system, method and apparatus for the modification of the scattering properties of an object. In particular, the effect may be achieved using non-magnetic materials.

### BACKGROUND

An object may be sought to be made invisible at least over some frequency range. This has been termed a “cloak of invisibility”; the invisibility sought may be partial at a specific frequency, or over a band of frequencies, so the term “cloak of invisibility” or “cloak” may take on a variety of meanings. The cloak may be designed to decrease scattering (particularly “backscattering”) from an object contained within, while at the same time reducing the shadow (“forward scattering”), so that the combination of the cloak and the object contained therein have a resemblance to free space. When the phrase “cloaking”, “cloak of invisibility” or the like, is used herein, the effect is generally acknowledged to be imperfect, and the object may appear in a distorted or attenuated form, or the background obscured by the object may be distorted or partially obscured.

In an aspect the cloak has a similarity to “stealth” technology where the objective is to make the object as invisible as possible in the reflection or backscattering direction. One means of doing this is to match the impedance of the stealth material to that of the electromagnetic wave at the boundary, but where the material is strongly attenuating to the electromagnetic waves, so that the energy backscattered from the object within the stealth material is strongly attenuated on reflection, and there is minimal electromagnetic reflection at the boundary within the design frequency range. This is typically used in evading radar in military applications. Shadowing may not be a consideration in stealth technology.

The materials used for the cloak may have properties where, generally the permeability and permittivity tensors are anisotropic and where the magnitudes of the permeability and permittivity are less than one, so that the phase velocity of the electromagnetic energy being bent around the cloaking region is greater than that of the group velocity.

Materials having such properties have not been discovered as natural substances, but may be produced as artificial, man-made materials, where the permittivity and permeability are less than unity, and may be negative. Metamaterials, an extension of the concept of artificial dielectrics, were first designed in the 1940s for microwave frequencies. They typically consist of periodic geometric structures of a guest material embedded in a host material. Analogous to the circumstance where homogeneous dielectrics owe their properties to the nanometer-scale structure of atoms, metamaterials derive their properties from the sub-wavelength structure of its component materials. At wavelengths much longer than the unit-cell size, the structure can be assigned parameters that may be used describe homogeneous dielectrics, such as electric permittivity and refractive index.

A first experimental demonstration of a cloak operating over a narrow band of microwave frequencies was recently reported. Cloaking was achieved by varying the dimensions of a series of split ring resonators (SRRs) to yield a desired gradient of permeability in the radial direction. However, there appear to be limits to size scaling of SRRs so as to exhibit magnetic responses in the optical range. Replacing the SRRs with other optical magnetic structures like paired nano-rods or nano-strips may be difficult, primarily due to fabrication issues. Moreover, optical magnetism based on, for example, resonant plasmonic structures is usually associated with a high loss factor, which may be detrimental to the performance of cloaking devices.

### SUMMARY

An apparatus is disclosed, the apparatus being a structure formed of a material having a permittivity less than unity and a permeability approximately equal to unity. The structural material may be a metamaterial: for example, a material having a permittivity greater than or equal to unity, partially filled with a material having a negative permittivity at a design wavelength. The permittivity of the material may be anisotropic.

In an aspect, the apparatus is sized and dimensioned such that the structure is disposable between an object and an observer.

A method of cloaking an object is described, the method including providing a structure formed of a metamaterial, and disposing the object to be cloaked such that the structure is positioned between the object and an observer. The metamaterial has a permittivity less than unity and a permittivity approximately equal to unity. The metamaterial may be fabricated from a dielectric with sub-wavelength inclusions of a material having a permittivity less than zero.

In another aspect, method of designing a cloaking structure includes, selecting a dielectric material; selecting a filler material having a permittivity less than zero; and, adjusting at least one of a distribution, a quantity or a dimension of the filler material within the dielectric material such that, at a design wavelength, a permittivity of a composite material comprised of the dielectric material and the filler material varies with a distance such that a visibility of an object disposed within the cloaking structure is reduced, and the region behind the object is visible.

In yet another aspect, a cloaked object, includes an object having a electromagnetic scattering property and a structure disposable between the object and an observer. The structure may be fabricated from a material having a permeability approximately equal to unity and a permittivity between approximately unity and approximately zero. The properties of the material may be selected so that a visibility of the object is reduced and a visibility of region behind the cloaked object may be substantially unaffected.

### BRIEF DESCRIPTION OF THE DRAWINGS

FIG. 1A illustrates the coordinate transformation that compresses a cylindrical region r<b into a concentric cylindrical shell a<r<b; and, 1B the structure of a non-magnetic optical cloak, together with a portion of the inner surface thereof;

FIG. 2A is a graph of the functions ƒ₀ and ƒ₁ as defined by (8) for a silver-silica composite with aspect ratios of 10:1, 20:1 and 50:1, respectively; 2B, the operational point determined by (11) for a cloak consisting of silver wires of α=10.7 in silica; and, 2C, the material parameters ∈ᵣ, ∈_{θ} and μ_{z} of the cloak operating at λ=632.8 nm, where the solid line (—) represents the exact set of reduced parameters by Eq. 2, and the diamond (⋄): parameters of the metal wire composite cloak; and

FIG. 3 is a cross-sectional view of finite-element simulations of the magnetic field mapping around the cloaked object with TM illumination at λ=632.8 nm when the object is surrounded by: A, a cloak with the exact set of reduced parameters; B, the metal wire composite cloak; and C, a vacuum (no cloak).

FIG. 4 shows a comparison of the anisotropic material properties for of the anisotropic material properties for the optimal quadratic design (p=a/b²), solid lines and the linear transformation (p=0), dashed lines. The shape factor a/b is 0.31 and the diameter 2b is 4 microns.

FIG. 5 shows the results of full-wave field-mapping simulations of the magnitudes of the normalized scattered field for a metal cylinder with: A, no cloak; B, an ideal cloak; C, a linear transformation non-magnetic cloak; and D, an optimal quadratic transformation nonmagnetic cloak; and

FIG. 6 shows scattering patterns from the four cases shown in FIG. 5; where A shows the metal cylinder scatterer with no cloak and the cylinder with the ideal cloak; and B shows the cylinder with a linear nonmagnetic cloak and the cylinder with an optimal quadratic nonmagnetic cloak.

### DETAILED DESCRIPTION

Exemplary embodiments may be better understood with reference to the drawings, but these embodiments are not intended to be of a limiting nature.

When the phrase “cloaking”, “cloak of invisibility” or the like is used herein, the effect is generally acknowledged to be imperfect in practice, and the object may appear in a distorted or attenuated form, or the background obscured by the object may be distorted or partially obscured. Therefore, “cloak” should not be interpreted so as to require that the object within the cloak be “invisible” even at a design wavelength.

Reference may be made in this application to systems, apparatus, components, or techniques that are known, so as to enable a person of ordinary skill in the art to be able to comprehend the examples disclosed in the specification. The examples are intended to enable a person of ordinary skill in the art to practice the inventive concepts as claimed herein, using systems, apparatus, components, or techniques that may be known, disclosed herein, or hereafter developed, or combinations thereof. Where a comparison of performance is made between the examples disclosed herein and any known system, apparatus, component, or technique, such comparison is made solely to permit a person of skill in the art to more conveniently understand the present novel system, apparatus, component, or technique, and it should be understood that, in complex systems, various configurations may exist where the comparisons made may be better, worse, or substantially the same, without implying that such results are invariably obtained or constitute a limitation on the performance which may be obtained.

A non-magnetic cloak structure of cylindrical geometry which may be operable at visible wavelengths is described. The cloak may be designed to be effective at other wavelengths, and in other geometries.

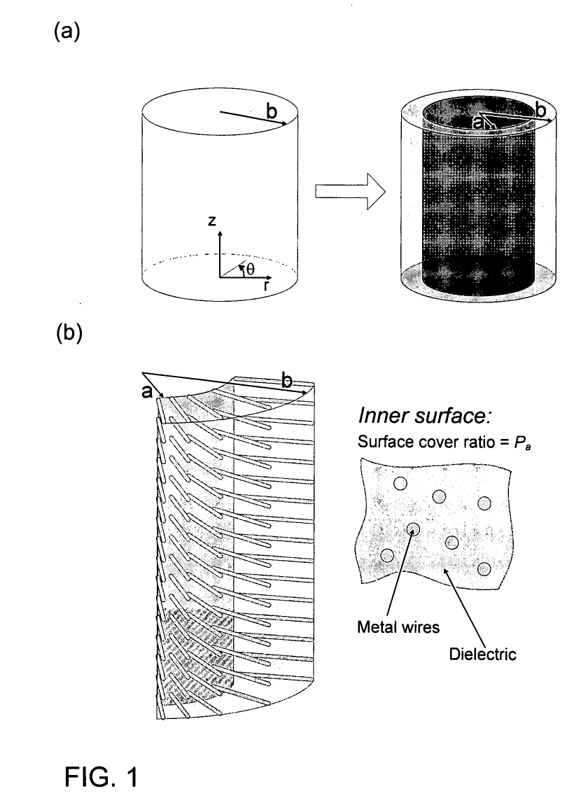

In a first example, a cylindrical geometry is selected. A coordinate transformation may be used where a cylindrical region r<b is compressed into a concentric cylindrical shell a<r<b as shown in FIG. 1A. There is no variation of permittivity or permeability along the z direction in the model geometry of this example.

Using a linear coordinate transformation results in the following properties for the anisotropic permittivity and permeability in a cloaking shell or structure:

$${ɛ}_{r} = {μ}_{r} = \frac{r - a}{r} , \\ {ɛ}_{θ} = {μ}_{θ} = \frac{r}{r - a} , {ɛ}_{z} = {μ}_{z} = {( \frac{b}{b - a} )}^{2} \frac{r - a}{r} \qquad ( 1 )$$

Mathematically, there are a variety of coordinate transformations that may be used, and while a linear transformation is used in this example, the optimization of a quadratic coordinate transformation is described in a second example. Such mathematical examples are convenient for discussion, but more complex transformations may be used and, in conjunction with electromagnetic finite-element analysis, to design more complex structures having differing properties, and include the effects of lossy materials.

For transverse electromagnetic (TE) illumination of the cylindrical system with the incident electrical field polarized along the z axis, only ε_{z}, μᵣ and μ_{θ} in (1) enter into Maxwell's equations. The dispersion properties and wave trajectory in the cloaking shell remain the same as long as the values of the products εᵢμⱼ are maintained constant, where i and j represent any of the two distinct subscripts among r, θ and z.

For transverse magnetic (TM) illumination of the cylindrical system with the incident magnetic field polarized along the z axis is considered, only μ_{z}, εᵣ and ε_{θ} may need to satisfy the requirements in (1), and the dispersion relations inside the cloak may remain unaffected as long as the product of μ_{z}εᵣ and μ_{z}ε_{θ} are maintained the same as the values determined by (1). Unlike the TE case, under TM illumination only one component of μ is of interest in the model. By multiplying εᵣ and ε_{θ} by the value of μ_{z}, a reduced set of cloaking shell parameters is obtained:

$$\begin{matrix}{μ}_{z} = 1 & ( 2 a ) \\ {ɛ}_{θ} = {( \frac{b}{b - a} )}^{2} & ( 2 b ) \\ {ɛ}_{r} = {( \frac{b}{b - a} )}^{2} {( \frac{r - a}{r} )}^{2} & ( 2 c )\end{matrix}$$

By the process of normalizing the parameters to the permeability such that μ_{z}=1, a material that does not exhibit magnetic properties within the effective frequency regime of the cloak may be used. The reduced set of parameters of (2) results in the same electromagnetic wave trajectories as for materials meeting the requirements of (1).

The ideal parameters in (1) result in a perfectly-matched impedance of Z=\sqrt{μ_{z}/ε_{θ}}=1 at r=b, while the reduced set in (2) produces an impedance at the outer boundary of Z=1−R_{ab}, where R_{ab}=a/b denotes the ratio between the inner and outer radii. R_{ab} may be termed the “shape factor” of the cylindrical structure. The level of power reflection or backscattering due to using reduced parameters in the design with a linear transformation can be estimated as |(1−Z)/(1+Z)|²=[R_{ab}/(2−R_{ab})]².

The azimuthal permittivity ε_{θ} is a constant with a value larger than 1, which can be achieved with the usual dielectric materials, although specially designed materials are not intended to be excluded. The cylindrical shell may be constructed with a desired radial distribution of εᵣ which may vary from 0 at the inner boundary (r=a) of the cloak to 1 at the outer surface (r=b).

The effect of using a material meeting the electromagnetic and spatial requirements of (2) is to guide incident electromagnetic waves such that they are excluded from the region interior to r=a, and which exit the cloaking region with minimal disturbance to the originally incident ray paths. As such, the background behind the object may appear to be substantially undisturbed by the presence of the object being cloaked.

Artificial dielectrics, such as metamaterials, with a positive permittivity εᵣ less than unity are known. In this example, the characteristics of εᵣ may be realized, for example, by using metal wires of sub-wavelength size disposed in a radial direction and embedded in a dielectric material, as shown FIG. 1B. The wires may be disposed perpendicular to the cylinder inner and outer surfaces. The spatial positions may not be periodic and may be random. For large cloaks, the wires may be broken into smaller pieces. The aspect ratio of the metal wires, defined by the ratio of the length to the radius of the wire, is denoted by α. The whole structure of the cloaking system may conceptually resemble a round hair brush (except that the “bristles” of such a “hair brush” may consist of disconnected smaller pieces, with either random or periodic distribution within the cylinder).

The metal material may be chosen so as to have a negative permittivity in the wavelength regime chose for the design. Metals from the noble metals such as gold, silver, tantalum, platinum, palladium or rhodium may be used. Other materials are known to exhibit negative permittivity, such as silicon carbide. These materials may be combined with dielectric materials having a permittivity greater than unity, so as to result in a metamaterial with an effective permittivity between about zero and unity.

The shape-dependent electromagnetic response of a sub-wavelength particle can be characterized by the Lorentz depolarization factor q. For an ellipsoid of semiaxes aᵢ, aⱼ and aₖ with electric field polarized along aᵢ, the depolarization factor may be expressed by:

$${q}_{i} = {\int }_{0}^{∞} \frac{{a}_{i} {a}_{j} {a}_{k} d s}{2 {( s + {a}_{i}^{2} )}^{3 / 2} {( s + {a}_{j}^{2} )}^{1 / 2} {( s + {a}_{k}^{2} )}^{1 / 2}} \qquad ( 3 )$$

Another commonly used parameter, the screening factor κ of a particle, is related to q by κ=(1−q)/q. A long wire with large aspect ratio α results in a small depolarization factor and a large screening factor, which generally indicates strong interactions between the electromagnetic fields and the wire.

For a composite cloak with metal wires as inclusions in a dielectric, the electromagnetic properties may be-described by “shape-dependent” effective-medium theory (EMT) that describes composites with particles of different shapes and thus different κ-factors. The effective permittivity ε_{eff} for a composite material comprising metal particles with permittivity εₘ a volume filling factor ƒ and screening factor κ, along with a dielectric component with permittivity ε_{d} and a filling factor 1−ƒ is given by:

$$f \frac{{ɛ}_{m} - {ɛ}_{eff}}{{ɛ}_{m} + κ {ɛ}_{eff}} + ( 1 - f ) \frac{{ɛ}_{d} - {ɛ}_{eff}}{{ɛ}_{d} + κ {ɛ}_{eff}} = 0 \qquad ( 4 )$$

For spherical particles with q=⅓ and κ=2, (4) reduces to the common EMT expression which is a quadratic equation with the following solutions:

$${ɛ}_{eff} = \frac{1}{2 κ} \{ \overline{ɛ} \pm \sqrt{{\overline{ɛ}}^{2} + 4 κ {ɛ}_{m} {ɛ}_{d}} \} \qquad ( 5 )$$

where ε̅=[(κ+1)ƒ−1]εₘ+[κ−(κ+1)ƒ]ε_{d}. The sign in (5) may be chosen such that ε_{eff}>0.

When using metal wires in a composite cloak, the radial permittivity εᵣ determined by (5) may exhibit a positive value less than 1 with a minimal imaginary part. Metamaterials having a metallic component may exhibit a permittivity that differs from unity, while having a permeability close to unity, and such material may be termed substantially non-magnetic so as to suggest that the permittivity characteristics are more important in achieving the cloaking.

For the structure in FIG. 1B, the volume filling fraction is inversely proportional to r. The filling fraction in the EMT formula for calculating εᵣ using (5) may be f(r)=Pₐ·(a/r), with Pₐ being the surface cover ratio of metal at the inner surface of the cloak (r=a). The filling fractions ƒ at the inner and outer surface of the cloak are Pₐ and Pₐ·(a/b) respectively, and the overall metal filling fraction in the whole cloak layer is Pₐ·2a/(a+b). The azimuthal permittivity ε_{θ} inside the cloak is substantially the same as that of the dielectric material because a response of wires to the angular electrical field E_{θ} oriented normally to the wires is small and, at low metal filling factors, it may generally be neglected.

The reduced set of cloak parameters in (2) is consistent with a smooth variation of the radial permittivity from 0 to 1 as r varies from a to b. That is,

$$\{ \begin{matrix}{ɛ}_{eff , r} ( {P}_{a} ) = 0 \\ {ɛ}_{eff , r} ( {P}_{a} \cdot a / b ) = 1\end{matrix} \qquad ( 6 )$$

The gradient in ε_{eff,r} may follow the function described in (2c) such that

$${ɛ}_{eff , r} ( {P}_{a} \cdot a / r ) = {( \frac{b}{b - a} )}^{2} {( \frac{r - a}{r} )}^{2} \qquad ( 7 )$$

In an actual design, ε_{eff,r} may have some deviation from the value given by (2c) inside the cloak. For example, in the reported microwave cloak with a layered structure, the desired permeability was fulfilled at only a few discrete positions along the radial direction, while in the majority of the cloak the material was air. At the inner and outer surfaces of the cloak, the conditions of (6) should be satisfied as closely as practical, although the conditions at the inner surface may be relaxed where there is a lossy component to the material. This may result in impedance index matching at r=b and minimal leaking energy at r=a.

To determine all the parameters of the design shown in FIG. 1B, the general properties of a metal-dielectric composite with thin metal wires in the radial direction as the inclusion are modeled. Two filling fraction functions ƒ₀(λ) and ƒ₁(λ) are such that for given constituent composite materials and for a fixed aspect ratio α of the wires, the effective radial permittivity is.

ε_{eff,r}(λ,ƒ₀(λ))=0 (8a)

and

ε_{eff,r}(λ,ƒ₁(λ))=1 (8b)

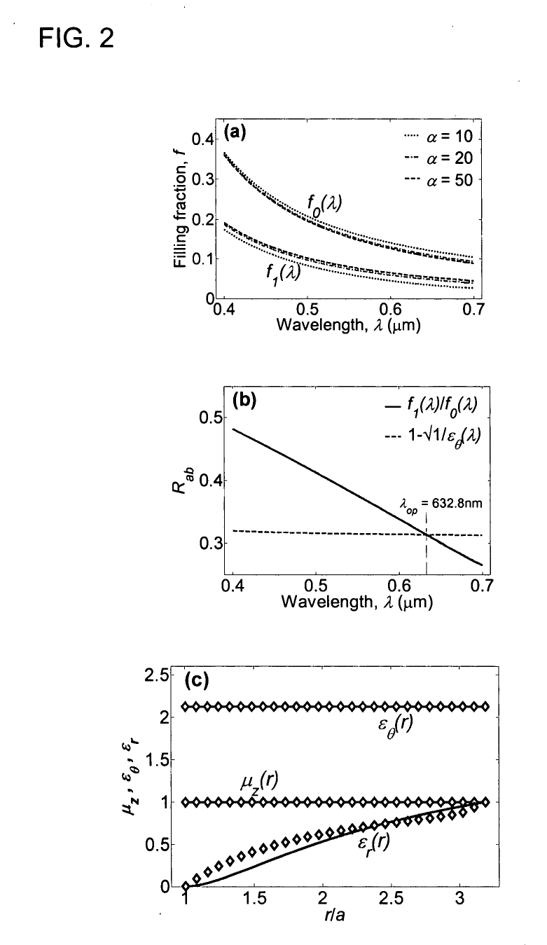

The values of ƒ₀(λ) and ƒ₁(λ) calculated from (5) and (8) for a silver-silica composite with α=10, 20 and 50 at visible wavelengths are plotted in FIG. 2A. In the calculation the metal permittivity is approximated by the Drude model, and the permittivity of the dielectric is calculated using Sellmeier equation.

Combining (6) and (8), at the design wavelength λ,

$$\{ \begin{matrix}{f}_{0} ( λ ) = {P}_{a} \\ {f}_{1} ( λ ) = {P}_{a} \cdot a / b\end{matrix} \qquad ( 9 )$$

From the above equations R_{ab} may be expressed as:

R_{ab}=ƒ₁(λ)/ƒ₀(λ) (10)

Using (10) with (2b), the operating condition of the cloak is obtained as:

ƒ₁(λ)/ƒ₀(λ)=1−\sqrt{1/ε_{θ}(λ)}, (11)

where ε_{θ}(λ) is the permittivity of the dielectric material surrounding the metal wires in the cloak. Thus, the geometrical factors of the cloak including R_{ab}, Pₐ and α are determined. The same design may work for similar cylindrical cloaks with the same shape factor R_{ab}. In FIG. 2B we show the operational point obtained by (11) is shown for a cloak consisting of silver wires with α=10.7 in silica.

A cloaking device or structure may be designed for operating at an operational wavelength λₒₚ. A method of designing a cloaking device may include the steps of: choosing materials that are available for the metal wires and the surrounding dielectric, or other metamaterials; and, calculating the values of ƒ₀ and ƒ₁ as functions of the aspect ratio α at λₒₚ using, for example, the EMT model in (5). Other models may also be used. The desired aspect ratio for λₒₚ corresponds to the fulfillment of (12).

$${ɛ}_{θ} ( {λ}_{op} ) = {( \frac{{f}_{0} ( {λ}_{op} , α )}{{f}_{0} ( {λ}_{op} , α ) - {f}_{1} ( {λ}_{op} , α )} )}^{2} \qquad ( 12 )$$

Then, the structure of the cloak can be determined from (9) and (10).

The “round brush” design for a non-magnetic cloak may permit constructing an appropriate device operating at desired wavelength, which may be an optical wavelength, by choosing the proper materials and structures. As an example, the design of an optical cloak operating at the frequently-used wavelength of 632.8 nm (He—Ne laser), and consisting of silver and silica is described.

Expressions (5), (8), and (12) yield the aspect ratio α=10.7, and the volume filling fractions at the two boundaries are f₀=0.125 and f₁=0.039, respectively. From (9) and (10) the shape factor of the cylindrical cloak is Rab=0.314 while the surface cover ratio at the inner boundary is Pₐ=12.5%. The effective parameters of μ_{z}, εᵣ and ε_{θ} from for this design and the set of reduced parameters from (2) are shown in FIG. 2C. As seen in FIG. 2C, μ_{z} and ε_{θ} match the theoretical requirements throughout the cylindrical cloak. In this example, the radial permittivity εᵣ fits the values required by (2) exactly at the two boundaries of the cloak, and follows the overall tendency relatively well inside the cloak. The imaginary part of εr is almost zero at r=b where εᵣ′(λₒₚ, b)=1 and reaches around 0.6 at the inner surface where εᵣ′(λₒₚ, a)=0. These quantities are similar to reported low-index metamaterials with periodic-metal-wire arrays.

The effects of loss can be addressed in several ways. As an example, if the aspect ratio of the wires is varied along the radial direction, the imaginary part of εᵣ may be smaller than 0.1 throughout the cloak. It may possible to compensate the loss by using a gain medium.

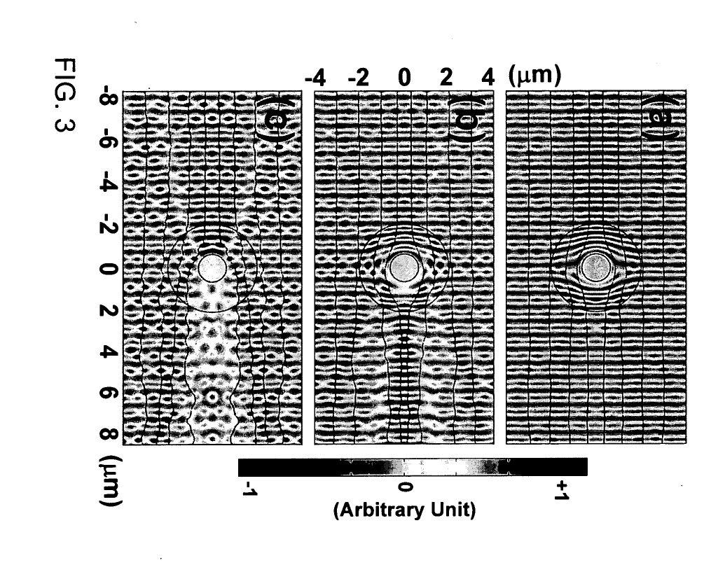

To illustrate the performance of the non-magnetic optical cloak with a design corresponding to FIG. 2C, a finite element method simulation using the commercial finite element package COMSOL Multiphysics (available from COMSOL, Inc. Burlington, Mass.) was performed. An ideal metallic cylinder with radius r=a is disposed within the cloaked region. The simulated results of magnetic field distribution around the cloaked object together with the power flow lines are illustrated in FIG. 3 for three cases. As shown in FIG. 3A, the cloak with the reduced set of material parameters represented by the solid curves in FIG. 2C leads to a small perturbation of the external fields, which is limited by imperfect impedance matching. FIG. 3B corresponds to a cloak with parameters given by the diamond shaped markers in FIG. 2C. Comparing the field maps in FIGS. 3A and 3B, the simulations for the designed cloak are in good agreement with the exact case. Without the cloak (FIG. 3C), the waves around the object are severely distorted and a clear shadow is cast behind the cylinder. These simulations show the capability of the structure described in reducing the scattering from the object inside the cloaked region.

The achievable invisibility with the example designed cloak is not perfect due to impedance mismatch associated with the reduced material specifications and the energy loss in a metal-dielectric structure.

In another aspect, a cloaking device can be based on vertical metal strips (instead of rods) placed in the radial directions within the cloaking structure. These strips can also be randomly or periodically disposed and may also consist of disconnected smaller strips. Chains of metal particles of various shapes may also be used.

In a second example, the coordinate transformation applied to (1) may be a high-order transformation such as a quadratic instead of the linear transformation. This example is one of a number of different analytic coordinate transformations which may be employed and illustrates a particular situation where the impedance is matched at the boundary between the cloaking cylinder and the assumed free space propagation medium of the incident electromagnetic wave.

By constraining the impedance of the outer boundary to be equal to that of the external propagation medium, an optimal quadratic coordinate transformation may be obtained as:

r=[(a/b((r′/b−2)+1]r′+a (13)

The shape factor a/b should be less than 0.5 in order to have a monotonic transformation. When evaluating the material properties at the outer boundary, r=b, the material parameters εᵣ, ε_{θ}, μᵣ, are each equal to unity. As such, the impedance mismatch at the boundary has been obviated for the case of reduced parameters.

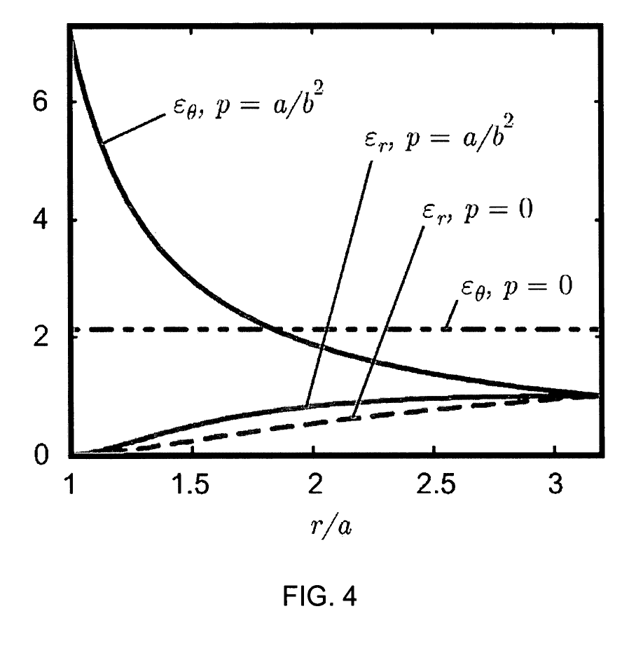

FIG. 4 compares the material properties of the non-magnetic cloak structures of the first and the second examples, where the shape factor a/b is 0.31, and the diameter (2b) is 4 micrometers and the wavelength λ=632.8 nanometers. The object disposed inside of the cloaks is an ideal metal cylinder with a radius that is the same as the inner surface; that is r=a. This may be a worst-case condition, and an arbitrarily shaped object of any configuration may be disposed inside of the inner surface with the same, similar, or better results.

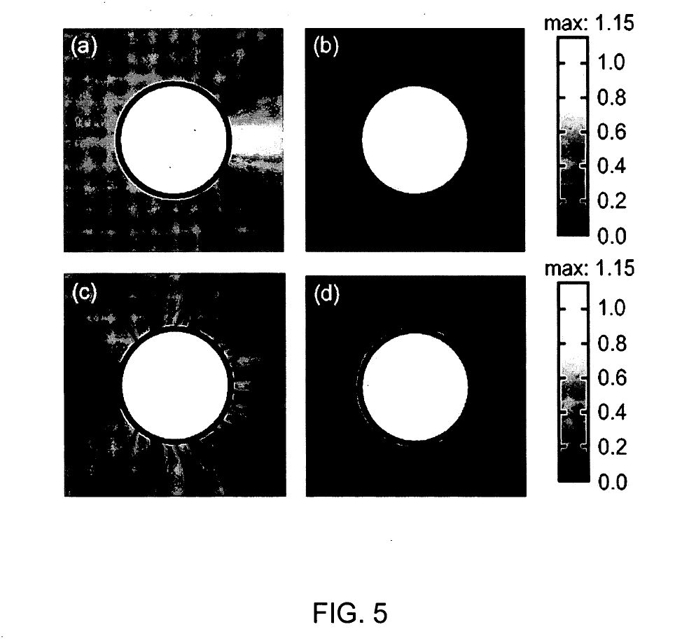

The results were computed using the same finite-element software package as used for the first example, and the normalized magnitudes of the scattered fields are shown in FIG. 5.

The scattered field from the cloaked metallic cylinder is itself is shown in FIG. 5A. The strong forward scattering observed at the right-hand side of the diagram corresponds to a shadow cast behind the object. An idealized cloak is shown in FIG. 5B, where the scattered field would be essentially zero in magnitude in all directions in the plane. These examples may be compared with the results obtained for the linear transformation (FIG. 5C) and the quadratic case (FIG. 5D). The linear case exhibits a scattering pattern from the outer boundary of the system, primarily due to the impedance mismatch. On the other hand, the quadratic transformation function results in substantially less scattering from the cloaking system. A figure of merit for cloaking, which may be defined as the ratio of the scattering cross sections with and without the cloak, is about 10 for quadratic cloak of the dimensions modeled, and it increases as the size of the cloaking system increases.

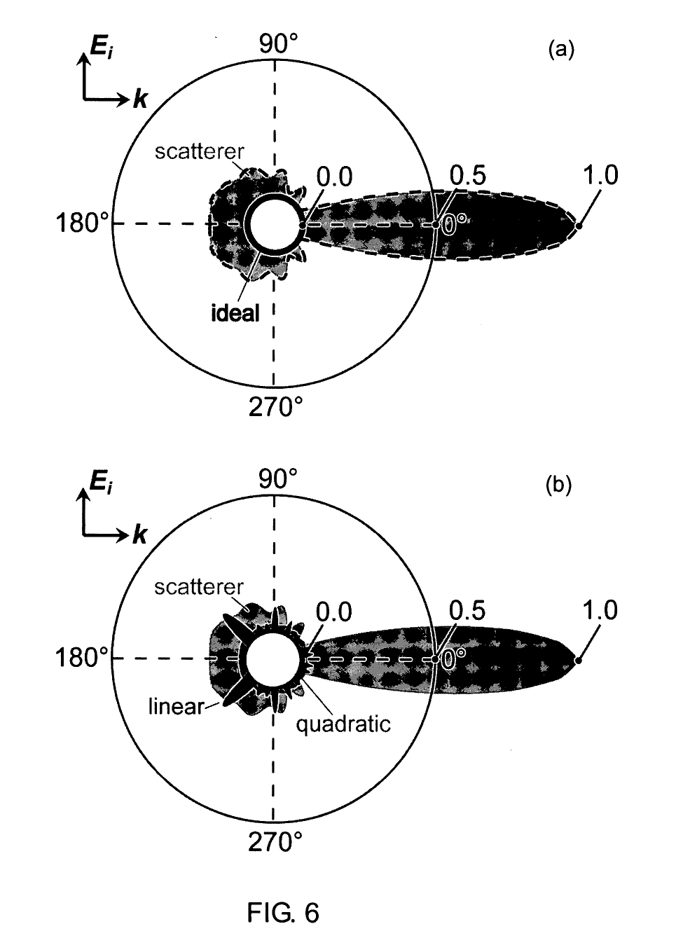

FIGS. 6 A and B. show the scattering radiation patterns corresponding to the four cases of FIG. 5. The curves in FIG. 6 show the energy flow in the radial direction normalized by the maximum value in the noncloaked case at a boundary outside the outer surface of the cloak structures. In the ideal cloaking system, the scattering energy flow is zero, which is indicated by the solid inner circle in FIG. 6A.

FIG. 6B shows that the linear cloak structure with reduced parameters exhibits a noticeable although smaller scattering, and has and strongly directional scattering pattern. However, for the nonmagnetic quadratic cloak, the overall scattering is much less significant. The peak value of the radial Poynting vector in the quadratic cloak is more than six times smaller than that of the linear example. Moreover, the directivity in the scattering pattern is substantially suppressed.

In another aspect, a cloaking device or structure may be a spherical or other shaped cloaking structure. The specific geometrical shape, the size and other design parameters of the structure, such as the spatial variation of permittivity, may be chosen using the general approach described herein so as to be adaptable to the wavelength, the degree of cloaking, and the properties of the object to be cloaked. Loss and gain may be introduced in various portions of the structure.

The examples shown herein have used analytic profiles for the material properties so as to illustrate certain of the principles which may influence design of cloaking structures. However, since electromagnetic simulations using finite element methods are commonly used in design of complex shapes, and have been shown herein to yield plausible results, the use of such simulations are envisaged as useful in design.

Certain aspects, advantages, and novel features of the claimed invention have been described herein. It would be understood by a person of skill in the art that not all advantages may be achieved in practicing a specific embodiment. The claimed invention may be embodied or carried out in a manner that achieves or optimizes one advantage or group of advantages as taught herein without necessarily achieving other advantages as may have been taught or suggested.

It is therefore intended that the foregoing detailed description be regarded as illustrative rather than limiting, and that it be understood that it is the following claims, including all equivalents, that are intended to define the spirit and scope of this invention.

What is claimed is:

1. A cloaking apparatus, comprising:
a structure formed of a material having a permittivity less than unity and a permeability approximately equal to unity,
wherein the material is a metamaterial.

2. The apparatus of claim 1, wherein the structure is disposable between an object and an observer.

3. The apparatus of claim 1, wherein the structure has a first surface and a second surface such that an object is disposable so that the second surface lies between the object and the first surface.

4. The apparatus of claim 3, wherein the permittivity of the metamaterial varies between approximately zero at an interface with the void and approximately unity at an outer radius of the cylinder.

5. The apparatus of claim 3, wherein the properties of the metamaterial are selected so that the power flow crossing the second surface in the direction of an object to be cloaked is minimized.

6. The apparatus of claim 3, wherein the properties of the metamaterial are selected so that the backscattering coefficient and the forward scattering coefficient of a combination of the structure and an object disposed such that the first and second surfaces are disposed between the object and a source of electromagnetic radiation are reduced.

7. The apparatus of claim 3, wherein the properties of the metamaterial include a variation of permittivity with distance between the first and the second surface.

8. The apparatus of claim 3, wherein the metamaterial has permittivity that is a function of the distance between the first surface and the second surface, and the variation of the permittivity is selected so that the impedance of the metamaterial at the first surface is the substantially the same as the impedance of a region outside of the structure and abutting the first surface.

9. The apparatus of claim 1, wherein the structure has at least one axis of symmetry.

10. The apparatus of claim 1, wherein the structure has a cylindrical symmetry, and an inner void.

11. The apparatus of claim 10, wherein an object is disposable in the inner void.

12. The apparatus of claim 10, wherein the permittivity of the metamaterial varies in a radial direction.

13. The apparatus of claim 1, wherein the permittivity is anisotropic.

14. The apparatus of claim 1, wherein the metamaterial comprises a dielectric material having a permittivity greater than or equal to unity partially filled with a material having a negative permittivity at a design wavelength.

15. The apparatus of claim 14, wherein the filler material is a plurality of sub-wavelength sized structures.

16. The apparatus of claim 14, wherein the material having a negative permittivity is a metal.

17. The apparatus of claim 16, wherein the metal is selected from a noble metal group.

18. The apparatus of claim 1, wherein the properties of the metamaterial are selected so that an impedance discontinuity between the metamaterial and an external environment is minimized.

19. The apparatus of claim 18, wherein a refractive index of the external environment is unity.

20. The apparatus of claim 1, wherein the properties of the metamaterial are selected so that the backscattering coefficient and the forward scattering coefficient of the structure are reduced.

21. The apparatus of claim 1, wherein the rate of change of an outer geometrical shape of the structure is slow when compared with a value of a design wavelength.

22. The apparatus of claim 1, wherein the metamaterial is lossless.

23. The apparatus of claim 1, wherein the metamaterial has a permeability of unity.

24. The apparatus of claim 1, wherein the properties of the metamaterial are selected so that a cloaking effect is a maximum at a visible wavelength of light.

25. The apparatus of claim 1, wherein the metamaterial includes a gain medium material.

26. A method of cloaking an object, the method comprising:
providing a structure formed of a metamaterial; and
disposing the object to be cloaked such that the structure is positioned between the object and an observer,
wherein the metamaterial has a permittivity less than unity and a permittivity approximately equal to unity.

27. The method of claim 16, wherein the metamaterial is a dielectric with sub-wavelength inclusions of a material having a permittivity less than zero.

28. The method of claim 26, wherein the object is surrounded by the structure.

29. A method of designing a cloaking structure, the method comprising:
selecting a dielectric material;
selecting a filler material having a permittivity less than zero; and
adjusting at least one of a distribution, a quantity or a dimension of the filler material within the dielectric material such that, at a design wavelength, a permittivity of a composite material comprised of the dielectric material and the filler material varies with a distance such that a visibility of an object disposed within the cloaking structure is reduced, and the region behind the object is visible.

30. The method of claim 29, where the energy reflected from a surface of the cloaking structure is substantially less than the energy that reflectable by the object without the cloaking structure.

31. The method of claim 29, wherein an outer geometrical shape of the cloaking structure is slowly varying with respect to the design wavelength.

32. The method of claim 29, wherein the composite material further includes a gain medium.

33. A cloaked object, the object comprising:
an object having a electromagnetic scattering property; and
a structure disposable between the object and an observer,
wherein the structure further comprises:
a material having a permeability approximately equal to unity and a permittivity between approximately unity and approximately zero.

34. The cloaked object of claim 33, wherein the properties of the material are selected so that a visibility of the object is reduced and a visibility of region behind the cloaked object is substantially unaffected.

35. The cloaked object of claim 33, wherein the properties of the metamaterial include the variation of permittivity as a function of a location within the structure.

36. The cloaked object of claim 33, wherein a design wavelength is within a visible light spectrum.

37. The cloaked object of claim 33, wherein the material further includes a gain medium.

38. The cloaked object of claim 33, where an outer geometrical shape of the structure varies slowly compared with a value of a design wavelength.
